(19) United States
(12) Patent Application Publication
(10) Pub. No.: US 2007/0124791 A1
(43) Pub. Date: May 31, 2007

(54) Content output device

(75) Inventors: Andreas Spechtler, Groedig (AT); Harald Sighart, Anthaing (AT)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Netservices GMBH, Anif (AU)

(21) Appl. No.: 10/572,585

(22) PCT Filed: Sep. 10, 2004
(86) PCT No.: PCT/EP04/10165

§ 371 Date: Mar. 20, 2006

(30) Foreign Application Priority Data
Sep. 25, 2003 (EP) 03021748.3

(51) Int. Cl. H04N 7/16; H04N 7/173; H04N 7/18; H04N 11/00; H04N 7/00

(52) U.S. Cl. 725/133; 725/141; 725/80; 348/552

(57) ABSTRACT

A content output device that includes a media player unit adapted to access content items from a first media source and to provide an output corresponding to the content items. The media player unit is further adapted to access at least one content item from at least one second media source and to provide an output corresponding to the at least one content item in a case an output corresponding to the content items from the first media source is requested and not possible or disrupted.

The present invention relates to a content output device and a method to provide content with a content output device, in particular to personal content output devices that receive the output content via a network, such as mobile phone that receives a media stream via a telecommunications network.

An example of such a content output device is a product for 2.5 G and 3 G telecommunications networks, which implements a Software Application (Client-Server) on a mobile phone receiving a media stream, e.g. audio, that is personalized, e.g. audio files selected and played in an order according to a user profile.

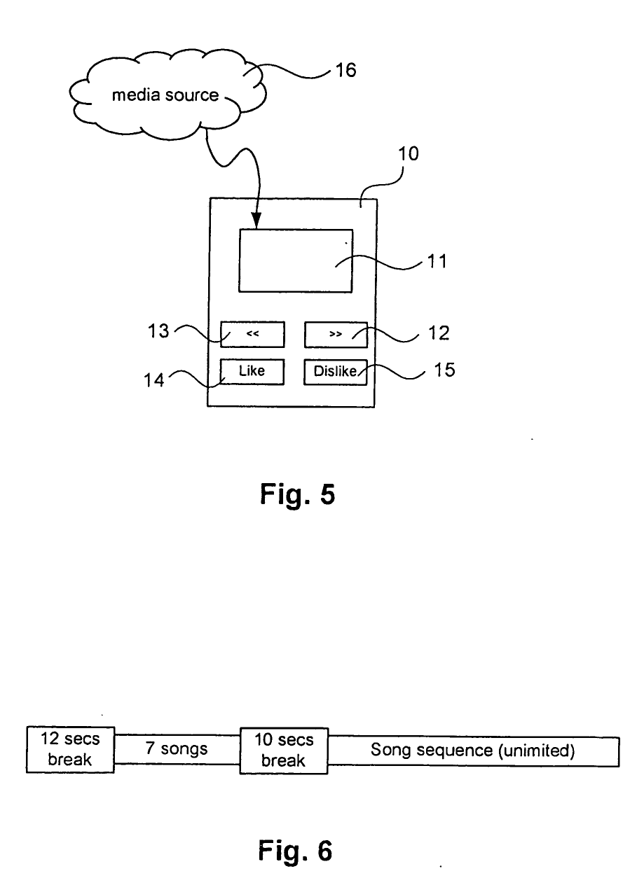

Such a content output device 10, is exemplary shown in FIG. 5. It incorporates a media player 11, here e.g. a music player, and controls for the media player, e.g. ‘Skip-Forward’ 12, ‘Skip-Backward’ 13, ‘Like’ 14, and ‘Dislike’ 15.

Users of the device 10 trigger an update of the media stream by pressing the controls. The client, i.e. the device 10, contacts a server 16 and requests a new media stream, e.g. when a currently song is rated to be disliked.

Before the new stream can be played, the media stream need to be buffered, i.e. stored, within the device 10, e.g. within device's media player 11. Such a buffering leads to a delay of app. 10 seconds in the user experience. Such a situation is shown in FIG. 6, wherein after a first skip/dislike indication by the user a first break of 12 seconds is performed before a new song sequence that is adapted to this user feedback is output. In the shown case the user again rates this media stream in the seventh song by a second skip/dislike indication, hereafter a 10 seconds break occurs until a newly adapted song sequence is output. As the song sequence output after the first skip/dislike indication, also the song sequence after the second skip/dislike indication is unlimited, i.e. songs will be continuously communicated to the content output device 10 and output from the content output device 10, until a next skip/dislike indication or other feedback or rating of the user to the currently output song sequence is given, in which case the content output device 10 initiates another adaptation of the media stream that carries the song sequence, which leads to another break.

However, these breaks are disturbing the hearing delight for the user and therefore the user might sometimes rather accept a not so liked song than a 10 seconds break. This results in a not properly adapted personalization.

Therefore, it is the object underlying the present invention to provide an improved content output device and method to provide content with a content output device.

This object is solved by a content output device according to independent claim 1 and a method to provide content with a content output device according to independent claim 10. Respective preferred embodiments thereof are respectively defined in the respective following sub-claims. A computer program product according to the present invention is defined in claim 17 and a computer readable storage means is defined in claim 18.

Therefore, in a content output device that comprises a media player unit adapted to access content items from a first media source and to provide an output corresponding to said content items, according to the present invention said media player unit is further adapted to access at least one content item from at least one second media source and to provide an output corresponding to said at least one content item in case an output corresponding to said content items from said first media source is requested and not possible or disrupted.

Correspondingly, a method to provide content with a content output device, comprising the step of accessing content items from a first media source and providing an output corresponding to said content items, according to the present invention further comprises the step of accessing at least one content item from at least one second media source and providing an output corresponding to said at least one content item in case an output corresponding to said content items from said first media source is requested and not possible or disrupted.

A content output device according to the present invention is preferably a personal device that can connect to a network, preferably wireless, such as a specially adapted mobile phone or PDA (personal digital assistant). However, according to the present invention also other content output devices are possible, e.g. computers, hi-fi components, television sets, radios, . . . . Content items according to the present invention might be music items, e.g. songs, uttered messages, melodies, sounds, video items, such as video clips or other motion pictures, with or without sound, pictures, text messages, texts, etc. . . . That an output corresponding to said content items from said first media source is requested and not possible or disrupted means that e.g. a media stream requested from said first media source needs to be buffered before the first media item is output and/or a preparation time is needed on the side of the first media source to set-up the media stream, or that a media stream is broken and will be restored later, i.e. that a content output wanted from a user of the content output device is currently not available, but will be available later, e.g. in a few seconds or minutes.

Therewith, the present invention reduces the experienced delay caused by buffering. In particular, in case this solution enhances the user experience so that the user does not realize that there is a delay due to buffering, a minimization of (experienced) buffering delay in streaming media over network is achieved.

In the content output device according to the present invention preferably said media player unit comprises a first media player to access content items from said first media source and a second media player to access said at least one content item from said second media source.

Therefore, according to this preferred embodiment of the present invention, the reduction of the buffering delay is achieved by utilizing 2 media players on the client. Alternatively, only one media player might be used that has the capability to appropriately access both media sources.

In the content output device according to the present invention alternatively or additionally preferably said first media source is arranged outside said content output device and provides said content items in form of a media stream to said media player unit.

Correspondingly, said method according to the present invention preferably comprises the step of receiving said content items of said first media source in form of a media stream.

In this case the present invention is particular effective, since the initialization of a requested media stream, which is a particular annoying matter for a user, is not recognized as a waiting period.

In the content output device according to the present invention further additionally preferably said content items provided by said first media source are buffered within said media player unit before said media player unit provides an output corresponding to said content items.

Correspondingly, said method according to the present invention further preferably comprises the step of buffering said content items provided by said first media source before providing an output corresponding to said content items.

Also in this case the present invention is particular effective, since not only the initialization of a requested media stream, but also an additional waiting time due to the buffering of an incoming media stream before it can be output is not recognized as a waiting period.

In the content output device according to the present invention still further alternatively or additionally preferably said content items provided by said first media source are personalized to a user of the content output device, wherein the media stream gets changed after a certain feedback of the user, which feedback is provided to the first media source.

In this case the present invention enables the proper collection of a user profile, since users are not discouraged to give feedback to a currently output media stream due to bothersome pauses of media output after feedback is given.

In the content output device according to the present invention still further alternatively or additionally preferably a content item provided by said first media source currently output gets faded out after said certain feedback of the user.

Correspondingly, said method according to the present invention still further preferably comprises the step of fading out a currently output content item after a change of the media stream was initiated.

This particular feature of the present invention further encourages a user to give feedback, since an immediate reaction to the certain feedback is provided, namely that after an indication of e.g. skip/dislike or a comparable feedback the currently output content item, which was actually rated, is not wholly output, but ended in an appropriate way.

In the content output device according to the present invention still further alternatively or additionally preferably said second media source is arranged within said content output device and provides said at least one content item as at least one corresponding direct accessible media file to said media player unit.

Correspondingly, said method according to the present invention still further preferably comprises the step of directly accessing said at least one content item from said second media source.

In this case it is secured that always an output corresponding to content items is available, since in pauses of the output of the streamed content items other content items of the second media source can readily be output.

In the content output device according to the present invention further additionally preferably said second media source is adapted to load or download said at least one content item that is provided by said second media source.

Correspondingly, said method according to the present invention still further preferably comprises the step of loading or downloading said at least one content item that is provided by said second media source so that it can be provided by said second media source.

This particular preferred embodiment of the present invention enables to use different content items to be output in case the output corresponding to the content items supplied by the first media source is requested and not possible or disrupted. In this way it is e.g. also possible to provide the user with varying information each time a user feedback is given. Such an information might be transmitted to the content output device in advance and then be output directly after the feedback to the currently output content item is given. It is also possible that different information items are transmitted in advance and a particular one thereof is output depending on the kind of feedback given.

Alternatively, only one media player might be provided that has the capability to buffer an incoming stream and to simultaneously provide an output of content items already available, e.g. stored. Of course, also these content items already available might be provided via a content item stream, i.e. media stream, which, however, is already in a state to be output.

According to the present invention said at least one content item provided by said second media source is preferably a jingle. A jingle in this sense means a prepared message, in particular a prepared and available audio and/or video item. As stated above, alternatively said at least one content item might also be at least one information item or at least one content item corresponding to the content items of the first media source.

A computer program product according to the present invention comprises computer program means adapted to perform the method steps as set-out above when being executed on a computer, digital signal processor or the like.

A computer readable storage means according to the present invention stores thereon a computer program product as set-out above.

For a better understanding of the invention and to further elucidate the invention, its features, objects and advantages, exemplary preferred embodiments thereof are described in detail by way of example while making reference to the accompanying drawings, wherein:

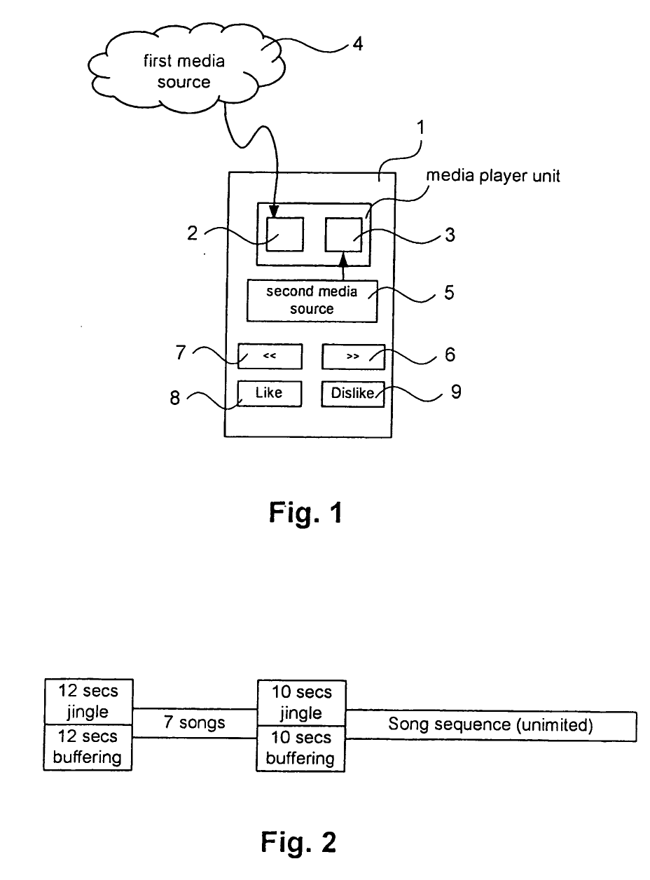

FIG. 1 shows a content output device according to an exemplary preferred embodiment of the present invention,

FIG. 2 shows a content output result of the content output device according to the preferred embodiment of the present invention shown in FIG. 1,

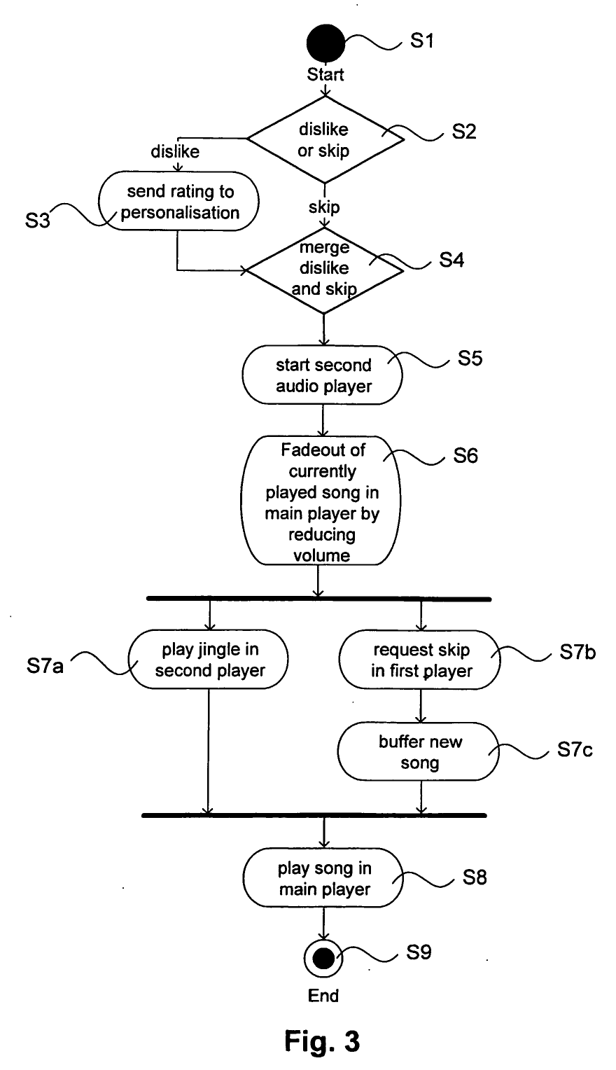

FIG. 3 shows a flow chart of the content output processing in the content output device according to the preferred embodiment of the present invention shown in FIG. 1,

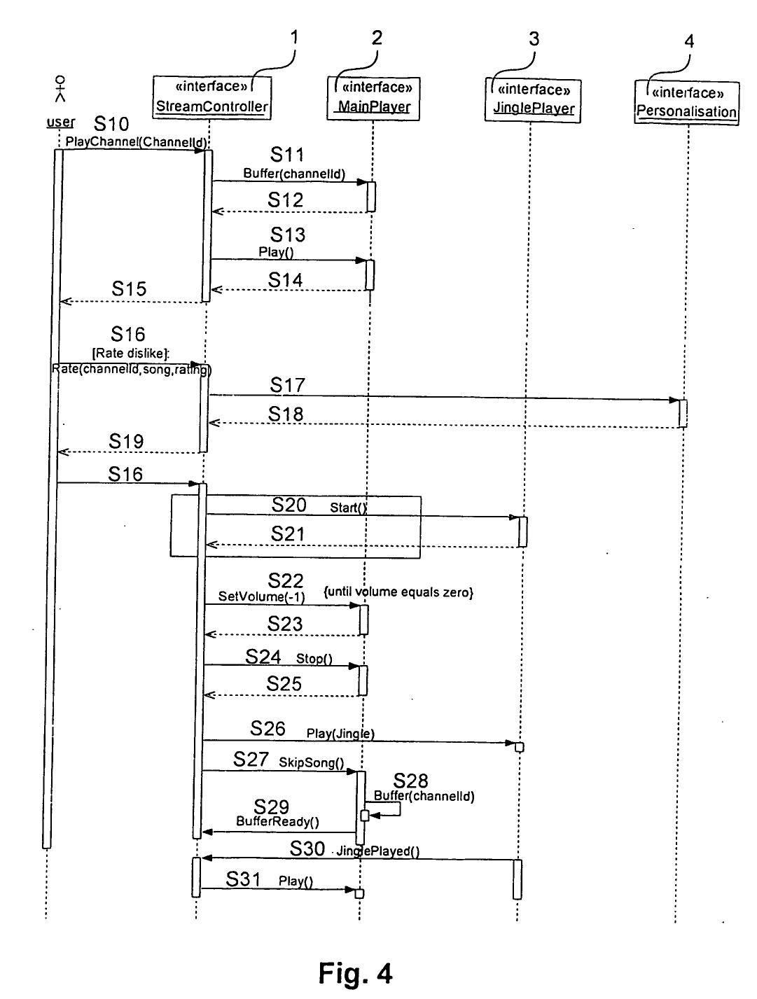

FIG. 4 shows a flow chart of implementation details of the content output processing in the content output device according to the preferred embodiment of the present invention shown in FIG. 1,

FIG. 5 shows a content output device according to the prior art, and

FIG. 6 shows a content output result of the content output device according to the prior art.

FIG. 1 shows a content output device according to an exemplary preferred embodiment of the present invention. Additionally to the content output device shown in and described in connection with FIG. 5, the content output device 1 according the exemplary preferred embodiment of the present invention comprises a second media player and an incorporated second media source.

Therewith, the content output device 1 incorporates a first media player 2 and a second media player 3, here e.g. music players, which together build a media player unit, an access to a first streaming media source 4, a second media source 5 that is incorporated within said content output device 1, and controls for the media players 2, 3, e.g. ‘Skip-Forward’ 6, ‘Skip-Backward’ 7, ‘Like’ 8, and ‘Dislike’ 9.

As in case of the content output device 10 according to the prior art, users of the content output device 1 according to the present invention trigger an update of a media stream provided from the first media source 4 (server) by pressing the controls. The client, i.e. the content output device 1 according to the present invention, contacts the first media source 4, i.e. the server, and requests a new media stream, e.g. when a currently song is rated to be disliked.

Before the new stream can be played, the media stream need to be buffered, i.e. stored, within the content output device 1 according to the present invention, e.g. within device's first media player 2. Such a buffering leads to a delay of app. 10 seconds until an output corresponding to the incoming stream can be provided. However, according to the present invention no break is disturbing the hearing delight for the user, since this time is filled by an output of the second media player 3 that accesses the second media source 5, which provides content items ready for output, e.g. since these content items are already stored within the content output device 1 according to the present invention or in any other way available in a direct accessible way, e.g. via a broadband connection to a server.

FIG. 2 shows an output of the content output device 1 according to the present invention. When, after a first skip/dislike indication by the user a first buffering of 12 seconds is performed before a new song sequence that is adapted to this user feedback is output, simultaneously a 12 second long jingle is output to the user via the second media player 3. After the buffering is completed the jingle is stopped and the song sequence that is adapted to this user feedback is output. In the shown case the user again rates this media stream in the seventh song by a second skip/dislike indication, hereafter a 10 seconds buffering occurs until a newly adapted song sequence is output. During this 10 seconds buffering again a jingle is output to the user via the second media player 3. As the song sequence output after the first skip/dislike indication, also the song sequence after the second skip/dislike indication is unlimited, i.e. songs will be continuously communicated to the first media player 2 within content output device 1 and be output, until a next skip/dislike indication or other feedback or rating of the user to the currently output song sequence is given, in which case the content output device 1 initiates another adaptation of the media stream that carries the song sequence, which leads to another buffering with simultaneous output of a jingle with corresponding length via the second media player 3.

FIG. 3 shows a flow chart of the content output processing in the content output device 1 according to the preferred embodiment of the present invention shown in FIG. 1.

In particular, the content output processing is started in a first step S1. Thereafter it is checked in a following second step S2 whether or not a skip/dislike user feedback is input into the content output device 1.

In case of dislike is input, in a following third step S3 an update of the user profile and therewith also of the currently received media stream that is output via the first media player 2 is requested, whereupon a fourth step S4 is performed. In case of skip is input in the second step S2, the processing directly continues with the fourth step S4. In the fourth step S4 the processing for an input of skip or an input of dislike is merged.

After the fourth step s4, a fifth step S5 follows in which the second audio player 3 is started. Then, a sixth step S6 follows in which the currently played song or other content item output by the first media player 2 is faded out, in case of a song e.g. by reducing the volume.

In the following a parallel processing within the first and second media players 2, 3 is performed in a seventh step S7. In particular, in a step S7a the second media player starts the output of a jingle and in a step S7b the first media player requests a skip of the currently streamed song followed by a buffering of a new song in a step S7c. The request of skip the song is also the correct command in case the user indicated that the currently output song is disliked, since in this case a new media stream is generated and therewith the next streamed song considers the changed user profile.

In case the buffering of the new song is completed, the newly buffered song is output by the first media player 2 in a following eighth step S8. Of course, the output of the jingle from the second media player 3 is stopped before. The processing finally ends in a following ninth step S9.

FIG. 4 shows a flow chart of implementation details of the content output processing in the content output device according to the preferred embodiment of the present invention shown in FIG. 1 by also indicating the interfaces used during the feedback processing. The single interfaces are referenced in FIG. 4 by the same reference numerals as the corresponding device or unit shown in FIG. 1. In particular, the content output device 1 comprises a stream controller interface that provides the stream control and user interaction, the first media player 2 comprises a main player interface, the second media player comprises a jingle player interface, and the first media source 4 comprises a personalisation interface.

In a first step S10 the user requests to play a particular content item channel with the stream controller interface 1. Thereafter, the stream controller interface 1 initiates to buffer this particular content item channel with the main player interface 2 in a following second step S11. After the main player interface 2 indicated completion of the buffering to the stream controller interface 1 in a following third step S12, the stream controller interface 1 initiates to play this particular content item channel with the main player interface 2 in a following fourth step S13. After the playing is started and this is confirmed from the main player interface 2 in a fifth step S14 to the stream controller interface 1, the stream controller interface 1 provides a respective feedback to the user in a following sixth step S15.

In case the user rates the currently played song with dislike in a following seventh step S16, the stream controller interface 1 initiates an update of the user profile with the personalisation interface 4 in a following eighth step S17. After the update of the user profile is confirmed from the personalisation interface 4 in a ninth step S18 to the stream controller interface 1, the stream controller interface 1 provides a respective feedback to the user in a following tenth step S19.

Simultaneously with the eighth step S17, the stream controller interface 1 initiates an initialization of the second media player 3 with the jingle player interface 3 in an eleventh step S20. After the initialization of the second media player 3 is confirmed from the jingle player interface 3 in a twelfth step S21 to the stream controller interface 1, the stream controller interface 1 instructs the main player interface 2 to fade out the currently played song in a following thirteenth step S22. After the fade out the currently played song is confirmed from the main player interface 2 in a fourteenth step S23 to the stream controller interface 1, the stream controller interface 1 instructs the jingle player interface 3 to play the jingle in a following fifteenth step S26.

Simultaneously with the fifteenth step S26, the stream controller interface 1 initiates a skipping of the currently streamed song with the main player interface 2 in a sixteenth step S27. Thereafter, the main player interface 2 initiates a buffering of the next streamed song in a following seventeenth step S28 and upon completion thereof confirms that the buffer is ready to the stream controller interface 1 in a following eighteenth step S29.

After the jingle player interface 3 indicated to the stream controller interface 1 that the jingle is played in a following nineteenth step S30, the stream controller interface 1 initiates a playing of the new song with the main player interface 2 in a twentieth step S30.

1-18. (canceled)

19. Content output device, comprising:
a media player unit adapted to access first content items from a first media source and to provide corresponding first content items as an output, wherein:
said media player unit is further adapted to access at least one second content item from at least one second media source and to provide a corresponding at least one second content item as an output when the response to a request for said first content items to be provided from said first media source is negative.

20. Content output device according to claim 19, wherein said media player unit comprises a first media player having access to said first content items from said first media source and a second media player having access to said second content items from said second media source.

21. Content output device according to claim 19, wherein said first media source is located outside of said content output device and is adapted to provide said first content items as a media stream to said media player unit.

22. Content output device according to claim 21, further comprising a buffer adapted to buffer said first content items provided by said first media source within said media player unit before said media player unit provides said first content items as an output.

23. Content output device according to claim 21, wherein said first media source is adapted to chose said first content items to be provided in dependence on user feedback on first content items provided by said first media source to said media player unit before.

24. Content output device according to claim 21, wherein said media player unit is adapted such that a first content item which is provided by said first media source and which is currently output is fadeable out in response to user feedback received by the content output device on first content items already provided.

25. Content output device according to claim 19, wherein said second media source is adapted to load or download said second content items from remote.

26. Content output device according to claim 25, wherein at least one second content item is a jingle.

27. Content output device according to claim 19, wherein the content output device is adapted to provide said second content items, when provided to a user of the content output device, from a prepared media file.

28. Method for providing content to a user by a content output device, the method comprising:
accessing first content items from a first media source and providing corresponding first content items as an output;
accessing at least one second content item from at least one second media source and providing a corresponding at least one second content item as an output, wherein
the second content items are provided where the response to a request for first content items to be provided from said first media source is negative.

29. Method according to claim 28, further comprising receiving said first content items of said first media source as a media stream.

30. Method according to claim 29, further comprising buffering said first content items provided by said first media source before providing said first content items as an output.

31. Method according to claim 29, further comprising fading out a currently output first content item after a change of said media stream has been initiated.

32. Method according to claim 28, further comprising loading or downloading said second content items by said second media source from a remote location.

33. Method according to claim 32, wherein at least one second content item is a jingle.

34. Method according to claim 28, wherein the second content items, when provided to a user, are provided at the content output device from a prepared media file.

35. Computer program product, comprising computer program means adapted to perform the method as defined in claim 28 when being executed on a computer or a digital signal processor.

36. Computer readable storage means, storing thereon a computer program product according to claim 35.
